(19) United States
(12) Patent Application Publication
(10) Pub. No.: US 2005/0015304 A1
(43) Pub. Date: Jan. 20, 2005

(54) Secure purchasing over the internet

(76) Inventors: Yigal Evroni, Herzelia (IL); Avi Beredjik, Givataim (IL); Ronen Juster, Savion (IL)

Correspondence Address: DR. MARK FRIEDMAN LTD.;C/O BILL POLKINGHORN, DISCOVERY DISPATCH, 9003 FLORIN WAY, UPPER MARLBORO, MD, 20772, US

(21) Appl. No.: 10/620,341

(22) Filed: Jul. 17, 2003

(51) Int. Cl. G06F 17/60

(52) U.S. Cl. 705/26

(57) ABSTRACT

A method for purchasing goods or services by a customer from an E-Merchant, including the steps of: establishing a connection between the customer and the E-Merchant over a distributed public network; the customer deciding to purchase at least one item from the E-Merchant using a charge card, the charge card having a plurality of associated charge card details; sending at least a part of the charge card details from a computer system of the customer to an authorizer of the charge card; sending a transaction summary of a transaction from the E-Merchant to the authorizer, the transaction including the at least one item; authorizing the transaction, by the authorizer; and sending a confirmation of the authorizing of the transaction to the E-Merchant, wherein all the above steps are performed such that the E-Merchant is prevented from receiving any part of the charge card details.

### FIELD AND BACKGROUND OF THE INVENTION

The present invention relates to purchasing goods or services over a distributed public network and, in particular, it concerns secure purchasing of goods and services over the Internet using a charge card.

Credit Card Fraud

By way of introduction, credit card fraud is a problem that affects the entire consumer credit industry. It is one of the fastest growing types of fraud and also one of the most difficult to prevent. Credit card fraud can occur in person or via the Internet. Most consumer action groups, police departments, retail stores, and agencies, such as Better Business Bureaus (BBB) and the FTC, routinely release information for consumers on how to avoid credit card fraud and identity theft. Nevertheless, there are numerous forms of credit card fraud that are committed by enterprising thieves, organized rings, business owners, and even otherwise legitimate cardholders. The Internet makes credit card fraud easy in many ways. For instance, lists of stolen credit card numbers and even programs to generate valid new numbers can be used to purchase goods online. The lack of face-to-face or voice contact on the Internet tends to make thieves more daring. The speed of the purchase also plays a role, as a transaction that may take minutes in a store is processed in seconds online. A thief can even repeatedly try various number and expiration date combinations until he or she successfully obtains card approval without fear of being denied.

Both Visa U.S.A. and MasterCard are rolling out state-of-the-art identity check offerings. Visa U.S.A. invited cardholders to link their cards to passwords that would be required when shopping at participating online stores. The new service, “Verified by Visa,” is designed to raise the level of security and allay fears of fraud that haunt many merchants and consumers. Verified by Visa is a way to authenticate online buyers to online sellers in which customers register for a password with the bank that issues their credit card. Merchants are linked back to the card issuer that verifies the cardholder's identity based on that password.

Internet Fraud

Fraud conducted through the Internet is as diverse as the Internet itself. There are various types of Internet fraud ranging from the interaction of buyer and seller in an electronic auction to the targeting of multiple victims with a fraud.

Auction fraud is the most common form of Internet fraud. Online users visit sites such as Ebay, Yahoo Auctions, and Ubid.com to buy and sell various items in an online format that resembles a real-life auction. Prospective buyers bid on almost any item imaginable from virtual property to antique merchandise. Upon winning, the victim sends payment for the auction item. The fraud occurs when the victim does not receive the item or receives an item of far less value than advertised. When attempting to resolve the problem, the victim frequently has little information on the seller other than an e-mail address. Attempts to communicate with the seller are met with no response or lengthy excuses.

Non-delivery is easily facilitated with anonymity over the Internet. Various fraudulent online retail schemes induce victims to send payment for merchandise and then deliver nothing in return or an item of far less value than expected. Conversely, merchants often deliver merchandise in good faith prior to receiving payment, but never receive payment for their wares. The same non-delivery occurs with services. Services that request payment in advance, such as travel fees or moving costs, are paid via the Internet but then the actual service is never rendered. On the other hand, sometimes services are completed, such as Web site design, but never paid for by the recipient. Both consumers and merchants are victims of non-delivery in online frauds. Web sites, spam e-mails, message boards, chatrooms, and various combinations of all four are used to lure in potential victims.

The prospect of getting rich quickly is the lure that draws victims to business opportunity scams. Spam e-mails allow criminals to batch out thousands of various moneymaking opportunities. In one common scheme, victims are asked to invest anywhere from $5 to thousands of dollars for a chance to earn money while working at home. Another scheme involves an Internet-based business opportunity to use your home computer to earn money. Often, the information and tools provided for alleged success in the aforementioned ventures are either fraudulent in nature or of minimal value.

Identity theft is the illegal use of someone's personal data such as name, social security number, or driver's license to obtain money, merchandise, or services by deception. In conjunction with Internet usage, online identity theft occurs when someone appropriates someone else's personal information without the victim's knowledge to commit fraud or theft. Appropriating credit card numbers, ordering merchandise online with pilfered personal information, and stealing funds from an online account, such as Paypal, are some of the most common forms of identity theft on the Internet.

Credit card fraud committed online is a multi-faceted crime. Initially, stolen or forged credit card numbers are used to purchase items from Web sites. In good faith, the merchant ships the merchandise to the suspect. Upon discovery that the credit card number has been used illegally, a charge-back is made by the credit card issuer to the merchant. Since the merchandise has already been shipped, the merchant is left without the merchandise and without payment. The owner of the credit card must dispute the purchases with the credit card issuer and resolve any resultant credit issues on their credit report. In many credit card fraud cases, there are actually multiple victims: the Web site merchant, the cardholder, and the card issuer. All who are affected must spend time and/or money resolving the fraudulent issue. There is also the additional crime that was committed in obtaining or stealing the credit card number in the first place.

Prior Art Internet Purchasing

Reference is now made to FIG. 1 and to FIGS. 1a to 1b, collectively referred to herein as FIG. 1, which are respectively a small scale view of a flow chart of a method for purchasing over the Internet in accordance with the prior art, and partial views thereof, wherein the small scale view indicates the positions of the parts shown in the partial views. First, a customer is browsing at the web site of an E-Merchant (block 10). An E-Merchant is defined herein as a business or enterprise, which enables payment for goods or services via a distributed public network. The customer makes selections and clicks on the “pay” button or icon. Then the customer provides the E-Merchant with his full charge card details (block 12). The E-Merchant receives the charge card details and bundles them with the transaction information and transmits the bundle to the financial institution as a request for transaction approval (block 14). The transaction information typically includes the transaction value and the details of the E-Merchant. The financial institution validates the E-Merchant information to see if the E-Merchant is a valid E-Merchant (block 16). Also, the financial institution validates the cardholder information to see if the cardholder is valid (block 18). Additionally, the financial institution checks the customer's available credit (block 20). If any of the above tests of blocks 16, 18 and 20 fail, the financial institution sends a unconfirmation message to the E-Merchant (block 22) and the transaction ends as a no bid transaction (block 24). Then, the transaction details including cardholder information are saved in the E-Merchant's database (block 26). If the tests of blocks 16, 18 and 20 pass, then the financial institution executes the transaction (block 28) and the financial institution sends a transaction confirmation to the merchant (block 30). Finally, the E-Merchant accepts the confirmation and delivers the goods (block 32) and the transaction details including cardholder information are saved in the E-Merchant's database (block 26). The above prior art method represents the method used to purchase goods or services over the Internet. This prior art method has several shortcomings as follows. First, as a matter of security for the E-Merchant, the users often need to register with the E-Merchant in order to define a user name and password. This process needs to be repeated for each E-Merchant. Users intensely dislike registering, as it is inconvenient, slow, and not a natural and intuitive method by which a person normally purchases goods or services. Additionally, the user needs to remember multiple user names and passwords. Second, users need to fill in one or more pages to provide their charge card details and adequate personal information in order to verify the charge card details. Third, Internet transactions are generally graded as “unsigned” transactions and therefore have a greater risk associated with them. Fourth, and maybe most importantly, the user's charge card and personal details are stored in the E-Merchant's database. The E-Merchant database is a target for hackers and fraud. Also, the E-Merchant may be a Spam web site, which only exists to collect charge card details in order to perform fraud with the charge card details. Fraud affects customer behavior, thereby affecting business growth on the Internet.

Of relevance to the present invention is U.S. Pat. No. 5,815,665 to Teper, et al. which teaches an online brokering service that provides user authentication and billing services to allow users to anonymously and securely purchase from E-Merchants. A shortcoming of the Teper et al. system is the requirement for both the customer and the E-Merchant to be registered with the brokering service. A further shortcoming of the Teper et al. system is that the system operates using user names and passwords.

Of particular relevance to the present invention is PCT publication number WO00/74007 to Lee, et al. which teaches a method for using a card reader with a smart chip to authenticate a user of a charge card to a remote server. This method is used to verify that the user of the charge card is the owner of the charge card by performing a comparison with the charge card details and information which is stored in the smart chip. The charge card details can then be used by the E-Merchant who is now more assured that the charge card is being used by its owner.

Of most relevance to the present invention is U.S. Pat. No. 6,332,134 to Foster, which describes a method for performing a financial transaction, wherein a cardholder makes a purchase from a merchant using credit established at a financial institution. The method begins when the merchant transmits a merchant offer including merchant information about the purchase to the cardholder. The cardholder transmits the merchant information along with the cardholder information to the financial institution. The financial institution then transmits payment for the purchase to a merchant account and sends a payment notification to the merchant indicating that payment for the purchase has been made and that the merchant-offer has been accepted. This method prevents the merchant from receiving any cardholder details. A shortcoming of the Foster system is due to the merchant sending merchant information to the customer. This system would not be adopted by E-Merchants, as E-Merchants would probably not agree to send this information on to the customer. Additionally, the E-Merchant is losing control of the credit authorization process by passing these details over to the customer. A further shortcoming of the Foster system is that the software of the financial institution will have to be modified in order to give an adequate transaction confirmation to the E-Merchant to include not only the unique transaction reference, currently used, but also the amount authorized. For example, the transaction confirmation will have to include the transaction amount to ensure that the customer did not tamper with the amount. Additionally, the transaction confirmation will have to include a transaction identifier. Therefore, the method of Foster is unlikely to be adopted due to objections by the E-Merchants as well as the Financial Institutions issuing the cards.

There is therefore a need for a method for purchasing goods or services over a distributed public network, such as the Internet, providing security and a natural purchasing interface for the customer and security for the E-Merchant and the Issuer. Additionally, there is a need for a method that does not require customer registration over the Internet, E-Merchant registration or changes to the software of the Issuer.

### SUMMARY OF THE INVENTION

The present invention is a system for secure purchasing over a distributed public network using a charge card and a method of operation thereof.

According to the teachings of the present invention there is provided, a method for purchasing goods or services by a customer from an E-Merchant, the customer having a customer computer system, the customer having a charge card, the charge card having a plurality of charge card details, the method comprising the steps of: (a) establishing a connection between the customer computer system and the E-Merchant over a distributed public network; (b) sending at least a part of the charge card details from the customer computer system to an authorizer of the charge card, bypassing the E-Merchant, in order to purchase at least one item from the E-Merchant; (c) sending a transaction summary from the E-Merchant to the authorizer, bypassing the customer computer system, the transaction summary being of a transaction being between the E-Merchant and the customer, the transaction including the at least one item; (d) authorizing the transaction, by the authorizer; and (e) sending a confirmation of the authorizing of the transaction to the E-Merchant.

According to a further feature of the present invention, all the steps are performed such that the E-Merchant is prevented from accessing the part of the charge card details.

According to a further feature of the present invention, the sending the part of the charge card details includes sending the part of the charge card details from the customer computer system of the customer to a “Bridge” Platform, bypassing the E-Merchant, and wherein the sending the transaction summary includes sending the transaction summary from the E-Merchant to the “Bridge” Platform, bypassing the customer computer system, the method further comprising the steps of: pairing the part of the charge card details with the transaction summary to form a combined transaction payment request package, by the “Bridge” Platform; and sending the combined transaction payment request package to the authorizer for the authorizing, by the “Bridge” Platform.

According to a further feature of the present invention, the step of pairing is performed using a unique identification for the transaction.

According to a further feature of the present invention, the sending the part of the charge card details includes sending the part of the charge card details and the unique identification from the customer computer system to the “Bridge” Platform, bypassing the E-Merchant and wherein the sending the transaction summary includes sending the transaction summary and the unique identification from the E-Merchant to the “Bridge” Platform, bypassing the customer computer system.

According to a further feature of the present invention, the unique identification is an identification of the connection between the customer and the E-Merchant over the distributed public network.

According to a further feature of the present invention, there is also provided the steps of: receiving the part of the charge card details by the “Bridge” Platform; and receiving the transaction summary by the “Bridge” Platform, wherein the receiving the part of the charge card details and the receiving the transaction summary are performed asynchronously.

According to a further feature of the present invention, there is also provided the steps of: receiving the confirmation from the authorizer, by the “Bridge” Platform; and sending the confirmation to the E-Merchant, by the “Bridge” Platform.

According to a further feature of the present invention, there is also provided the step of sending the confirmation to the customer, by the “Bridge” Platform.

According to a further feature of the present invention, the confirmation includes a transaction authorization reference of the authorizer.

According to a further feature of the present invention, the sending the part of the charge card details is performed at least partially via the distributed public network.

According to a further feature of the present invention, there is also provided the step of prior to performing the sending of the part of the charge card details, performing at least one action selected from the group consisting of encoding the part of the charge card details and encrypting the part of the charge card details.

According to a further feature of the present invention, the transaction summary includes at least one merchant detail of the E-Merchant.

According to a further feature of the present invention, there is also provided the step of performing a validation of the E-Merchant, by the authorizer.

According to a further feature of the present invention, there is also provided the step of performing a validation of the part of the charge card details, by the authorizer.

According to a further feature of the present invention, there is also provided the step of paying the E-Merchant for the transaction.

According to a further feature of the present invention, there is also provided the step of delivering the at least one item, by the E-Merchant.

According to a further feature of the present invention, there is also provided the step of reading the part of the charge card details from the charge card, by a card reader.

According to a further feature of the present invention, there is also provided the step of swiping the charge card through the card reader, by the customer, thereby enabling the card reader to read the part of the charge card details.

According to a further feature of the present invention, there is also provided the step of verifying a usage of the charge card by comparing a unique code associated with the card reader and at least a portion of the charge card details, wherein the step of sending the at least one charge card detail is contingent on the step of verifying.

According to a further feature of the present invention, there is also provided the step of storing the unique code in a non-volatile storage medium of the card reader.

According to the teachings of the present invention there is also provided, a system for secure purchasing by customers over a distributed public network, comprising: (a) a plurality of customer computer systems, each of the customer computer systems being uniquely associated with one of the customers; (b) a plurality of servers associated hosting a plurality of E-Merchants, the customer computer systems and the E-Merchants being configured to establish connections over the distributed public network in order for at least one of the customers to purchase at least one item from one of the E-Merchants; (c) a computer system hosting a “Bridge” platform configured to pair: (i) a transaction summary sent by the one E-Merchant to the “Bridge” platform, bypassing the one customer; and (ii) at least part of a charge card details of a credit card of the one customer, sent by the one customer to the “Bridge” platform, bypassing the one E-Merchant, in order to form a combined transaction payment request package; and (d) at least one card issuer configured to authorize the combined transaction payment request package sent by the “Bridge” platform.

According to a further feature of the present invention, each of the customer computer systems includes a card reader configured for reading card details of the customers for sending to the “Bridge” platform.

### BRIEF DESCRIPTION OF THE DRAWINGS

The invention is herein described, by way of example only, with reference to the accompanying drawings, wherein:

FIG. 1 and FIGS. 1a to 1b, collectively referred to herein as FIG. 1, are respectively a small scale view of a flow chart of a method for purchasing over the Internet in accordance with the prior art, and partial views thereof, wherein the small scale view indicates the positions of the parts shown in the partial views;

FIG. 2 is a schematic diagram of a system, for purchasing over a distributed public network using a charge card, that is constructed and operable in accordance with a preferred embodiment of the invention;

FIG. 3 is a schematic diagram showing the information flow of a purchase over a distributed public network using the system of FIG. 2; and

FIG. 4 and FIGS. 4a to 4b, collectively referred to herein as FIG. 4, are respectively a small scale view of a flow chart of a method for purchasing over a distributed public network using the system of FIG. 2, and partial views thereof, wherein the small scale view indicates the positions of the parts shown in the partial views.

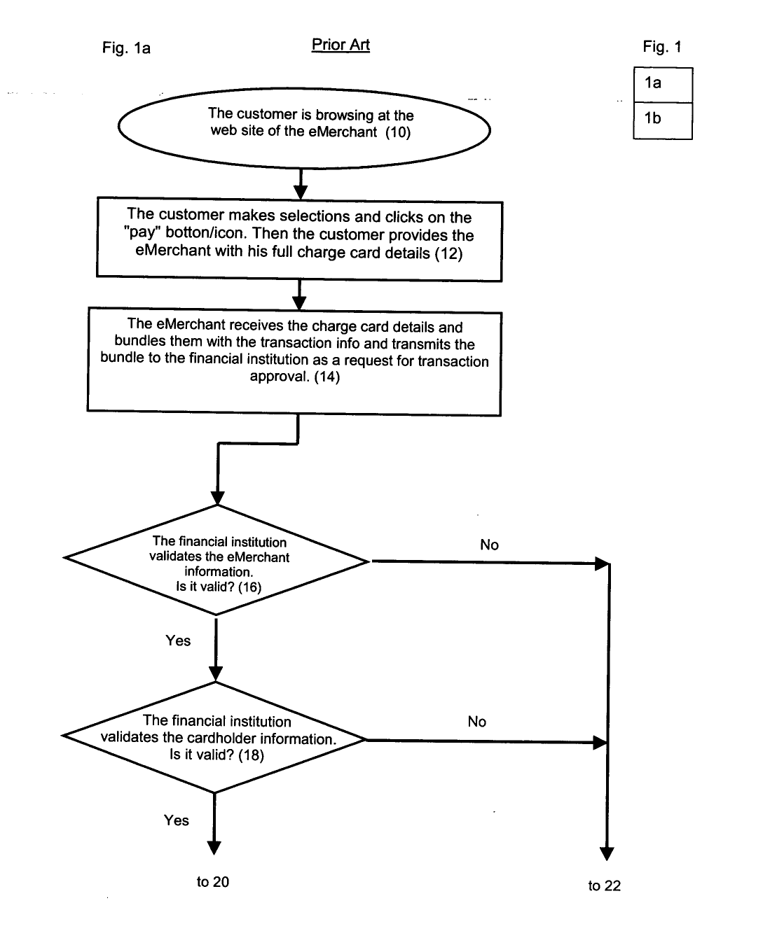

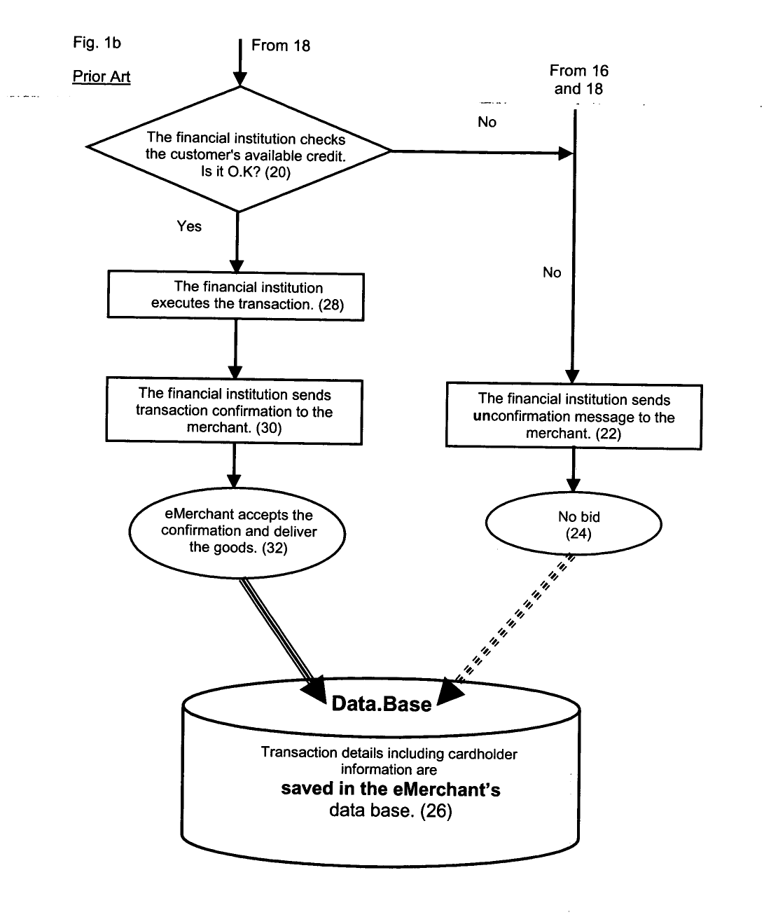

### DESCRIPTION OF THE PREFERRED EMBODIMENTS

The present invention is a system for secure purchasing over a distributed public network using a charge card and method of operation thereof.

The principles and operation of a system for secure purchasing over a distributed public network using a charge card according to the present invention may be better understood with reference to the drawings and the accompanying description.

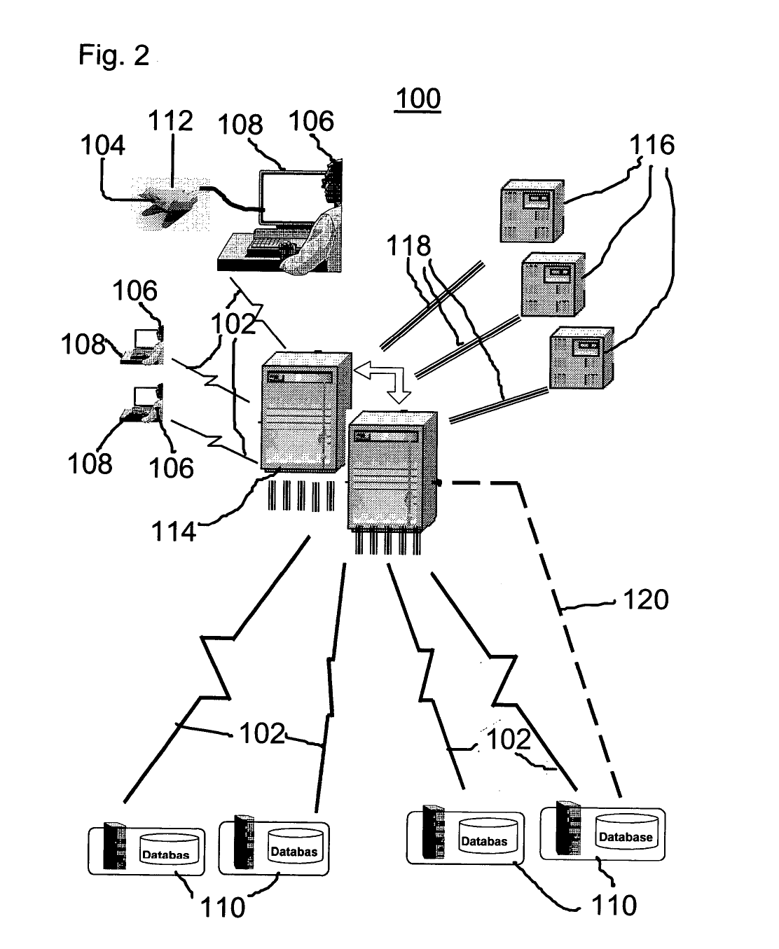

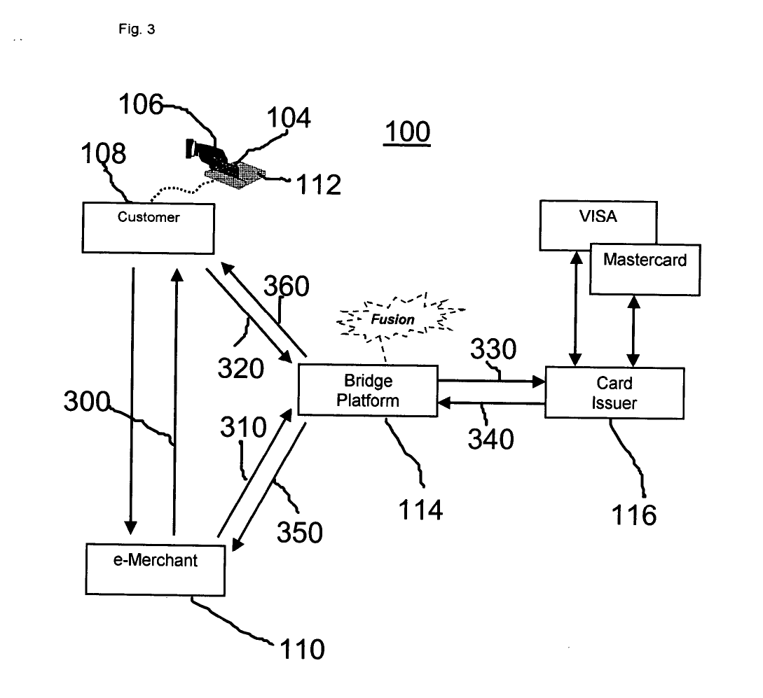

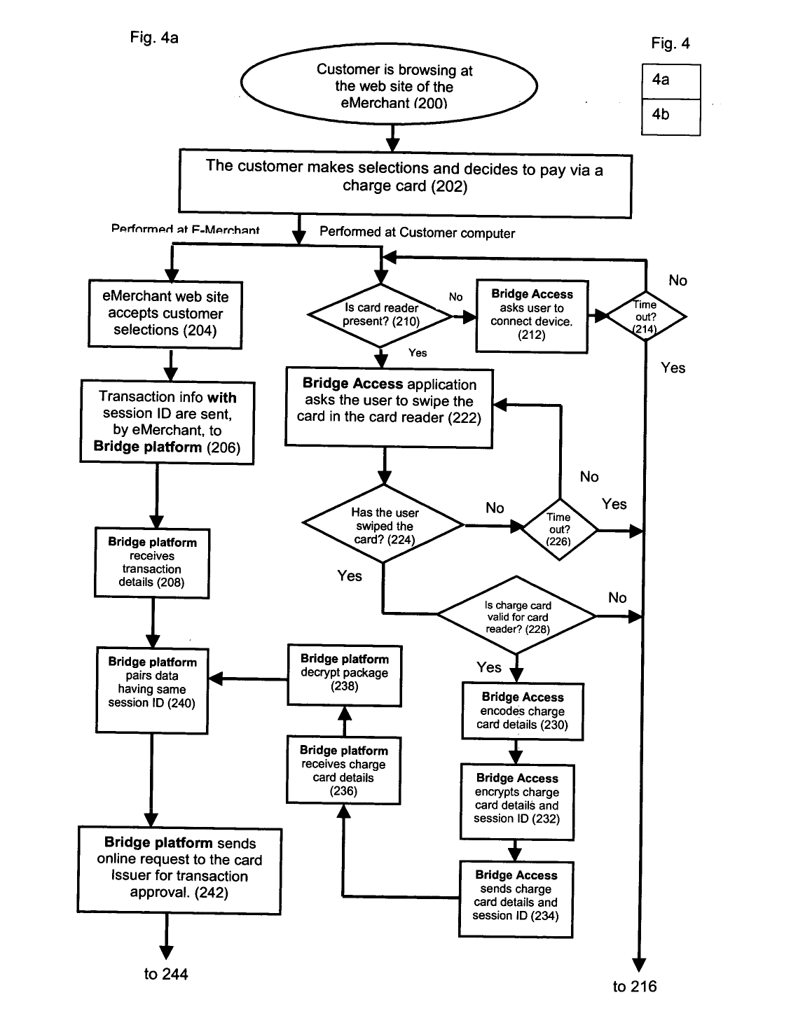

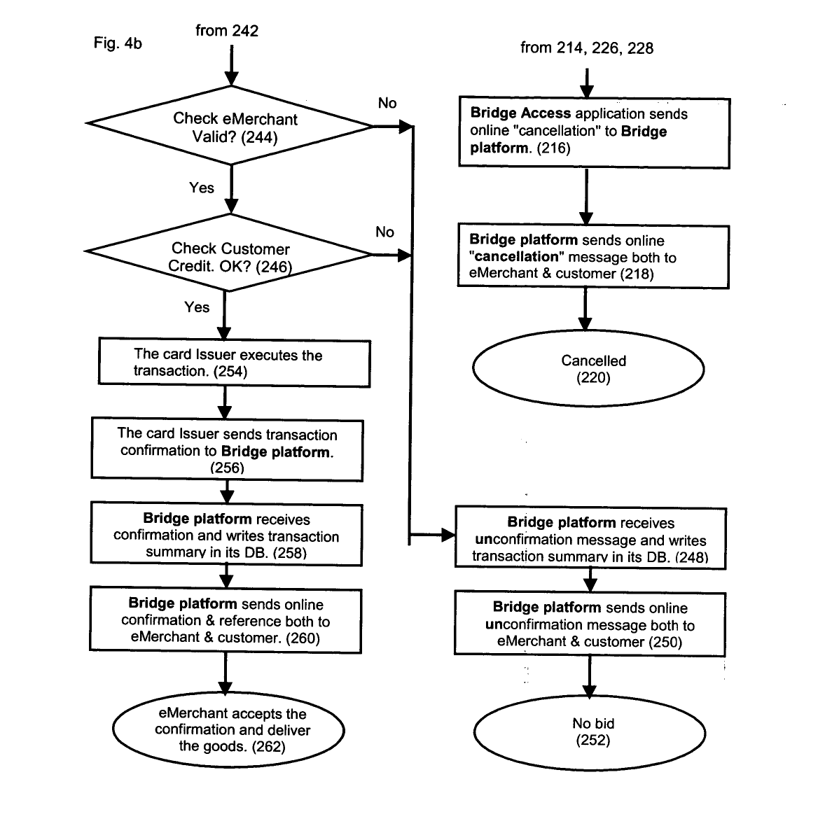

Reference is now made to FIG. 2, which is a schematic diagram of a system 100 for purchasing over a distributed public network 102, such as the Internet that is constructed and operable in accordance with a preferred embodiment of the invention. The following is an overview of system 100, a more detailed description of the system and method of the present invention is described with reference to FIGS. 3 and 4. System 100 includes a plurality of customers 106 each having a charge card 104 and a computer system 108, a plurality of E-Merchants 110, a plurality of card issuers 116 and a “Bridge” Platform 114. Computer system 108 is generally a processor having a user interface, such as personal digital assistant (PDA) or a personal computer system with a keyboard, mouse and monitor. Computer systems 108, E-Merchants 110 and “Bridge” Platform 114 generally communicate over distributed public network 102. “Bridge” Platform 114 communicates with card issuer 116 over a plurality of secured lines 118. An overview of the operation of system 100 is as follows. One of customers 106 selects items for purchase from one of E-Merchants 110. Each E-Merchant 110 markets goods and/or services via a web site which is hosted on a server. Once customer 106 has finalized selecting, customer 106 chooses to pay using his/her charge card 104 via an innovative system referred to herein as “Bridge”. Customer 106 swipes charge card 104 through a card reader 112, which reads the details of charge card 104. The details of charge card 104 are then encoded and encrypted by a client software package referred to herein as “Bridge Access” client software, operating on computer system 108 of customer 106. Computer system 108 then sends the details of charge card 104 via distributed public network 102 to “Bridge” Platform 114. E-Merchant 110 sends the transaction details including the merchant details to “Bridge” Platform 114, optionally, either via distributed public network 102 or via a direct line 120. “Bridge” Platform 114 then pairs the charge card details and the transaction details to form a single package. This single package is sent by “Bridge” Platform 114 to the appropriate card issuer 116 of charge card 104 via one of secured lines 118. Card issuer 116 then checks the validity of E-Merchant 110 as well as the validity and credit of charge card 104. Card issuer 116 then either issues a transaction confirmation or unconfirmation to “Bridge” Platform 114. “Bridge” Platform 114 then sends the transaction confirmation or unconfirmation to E-Merchant 110 and customer 106 at computer system 108.

System 100 has the following advantages over the prior art. First, details of charge cards 104 are never passed to E-Merchants 110. Second, merchant details are sent by E-Merchants 110 directly to “Bridge” Platform 114 and not via customers 106. Third, customers 106 do not have to register with E-Merchants 110. Fourth, customers 106 do not have to fill in one or more pages relating to charge card and personal details on the web sites of E-Merchants 110. Fifth, customers 106 and E-Merchants 110 do not need to register with “Bridge” Platform 114. Sixth, customers 106 do not have a user name and password to apply for and remember. Seventh, customers 106 pays for goods or services in a natural and intuitive way by swiping charge cards 104 through a card reader. Eighth, “Bridge” Platform 114 interacts with card issuers 116 in the same way that Visa or MasterCard currently interact with card issuers 116. Therefore, there is no need to change any method at card issuers 116. It should be noted that minor system changes are needed at E-Merchants 110 to allow payment via “Bridge”. Ninth, customers 106 can anonymously and securely purchase goods or services from E-Merchants 110 over any distributed public network. Tenth, customer 106 have confidence that their charge card information is not transmitted over an insecure distributed public network as the charge card details are encoded and encrypted.

Reference is now made to FIG. 3, which is a schematic diagram showing the information flow of a purchase over distributed public network 102 using system 100 of FIG. 2. Reference is also made to FIG. 4 and FIGS. 4a to 4b, collectively referred to herein as FIG. 4, which are respectively a small scale view of a flow chart of a method for purchasing over a distributed public network using system 100 of FIG. 2, and partial views thereof, wherein the small scale view indicates the positions of the parts shown in the partial views. Reference is also made to FIG. 2. First, customer 106 establishes a connection with E-Merchant 110 over distributed public network 102 (arrows 300). Customer 106 then browses the web site of E-Merchant 110 (block 200). Customer 106 makes selections and decides to purchase at least one item from E-Merchant 110 using charge card 104 (block 202). An “Item” for purchase is defined herein to include any good or service including making donations, paying for membership or paying subscription fees. Charge card 104 has a plurality of associated charge card details, such as card number, cardholder name, expiry date and issue number. The scope of the term “Charge card” is defined herein to include any debit or credit card or similar means to facilitate electronic purchasing. Customer 106 selects to pay using “Bridge”. E-Merchant 110 accepts the selections of customer 106 (block 204). E-Merchant 110 sends a transaction summary and a unique identification of the transaction directly to “Bridge” Platform 114 (over distributed public network 102 or direct-line 120) bypassing computer system 108 (block 206 and arrow 310). The term “bypassing computer system 108” is defined herein to exclude sending the transaction summary from E-Merchant 110 to or via computer system 108 in a form in which computer system 108 is able to determine the details of the transaction summary. Generally E-Merchant 110 does not send the transaction summary via or to computer system 108 in any form. The transaction summary includes enough details of the transaction between customer 106 and E-Merchant 110 to enable card issuer 116 to authorize the transaction. Additionally, the transaction summary includes details of the E-Merchant, such as Merchant name, Merchant ID or other details currently used by E-Merchants and Card issuers to identify the E-Merchants. The unique identification of the transaction is typically an identification of the connection between customer 106 and E-Merchant 110 over distributed public network 102, for example, a session ID. In accordance with an alternate embodiment of the present invention, E-Merchant 110 sends the transaction summary to an authorizer, which is generally card issuer 116, bypassing computer system 108. In accordance with this alternate embodiment, card issuer 116 needs to make changes to its own system. The term “sending to the authorizer” as used herein, in the claims, includes sending directly or indirectly to the authorizer, for example, sending to the authorizer via “Bridge” Platform 114. “Bridge” Platform 114 receives the transaction summary (block 208). Meanwhile, “Bridge Access” client software handles sending the details of charge card 104 to “Bridge” Platform 114. “Bridge Access” is generally configured as pop-up software which operates automatically. First, “Bridge Access” checks whether card reader 112 is connected to computer system 108 (block 210). Card reader 112 has a non-volatile storage medium, such as a smart chip (not shown), which stores a unique code thereon. If card reader 112 is not connected to computer system 108, “Bridge Access” asks customer 106 to connect card reader 112 (block 212). “Bridge Access” waits a predetermined time out (block 214) before canceling the transaction. If the time out is exceeded, “Bridge Access” sends an online cancellation notification to “Bridge” Platform 114 (block 216 and arrow 320). “Bridge” Platform 114 then sends an online cancellation message to E-Merchant 110 and customer 106 (block 218 arrows 360 and 350). The transaction is then considered cancelled (block 220). Once card reader 112 is connected, “Bridge Access” asks customer 106 to swipe charge card 104 through card reader 112 (block 222). “Bridge Access” checks for swiping of charge card 104 (block 224) for a predetermined timeout (block 226) after which the transaction is cancelled, as described above. As customer 106 swipes charge card 104 through card reader 112, card reader 112 reads the charge card details of charge card 104. “Bridge Access” verifies the usage of charge card 104 by comparing the unique code associated with the smart chip of card reader 112 and the charge card details (block 228). In other words, “Bridge Access” verifies that charge card 104 is being used by the rightful owner of charge card 104. It is very unlikely, that charge card 104 and card reader 112 are being used together by someone other than the rightful owner of charge card 104, except possibly by close relatives of customer 106 or when both charge card 104 and card reader 112 are stolen together. If the verification proves negative the transaction is canceled, as described above. If the verification proves positive the transaction proceeds as follows. “Bridge Access” encodes the charge card details, and optionally the unique code associated with the smart chip, using methods known in the art, such as convolution or derivatives (block 230). “Bridge Access” then encrypts the session ID and encoded charge card details using method known in the art, such as SSL or RCA (block 232). “Bridge Access” then sends the charge card details and the unique identification of the transaction from computer system 108 directly to “Bridge” Platform 114 over distributed public network 102, bypassing E-Merchant 110 (block 234 and arrow 320). The term “bypassing E-Merchant 110” is defined herein to exclude either sending the charge card details from computer system 108 to or via E-Merchant 110 in a form in which E-Merchant 110 is able to determine the charge card details. Generally computer system 108 does not send the charge card details via or to E-Merchant 110 in any form. It should be noted that distributed public network 102 is generally defined as being “insecure”, in that data could be intercepted and used fraudulently if not adequately protected by encoding and/or encrypting. In accordance with the alternate embodiment of the present invention, “Bridge Access” sends the transaction summary from computer system 108 to the authorizer, which is generally card issuer 116, bypassing E-Merchant 110. “Bridge” Platform 114 then receives the charge card details and the unique identification of the transaction (block 236). The charge card details and the transaction summary are received by “Bridge” Platform 114 asynchronously. “Bridge” Platform 114 decrypts the package received from computer system 108 (block 238). “Bridge” Platform 114 then pairs the charge card details with the transaction summary to form a combined transaction payment request package using the unique identification of the transaction. In other words, “Bridge” Platform 114 pairs data having the same session ID (block 240). “Bridge” Platform 114 sends the combined transaction payment request package to the authorizer which is generally card issuer 116, for authorizing via secured line 118 (block 242 and arrow 330). The authorizer performs a validation check of E-Merchant 110 (block 244). If the E-Merchant 110 is valid then the authorizer performs a validation check of the charge card details to see if the card is valid as well as checking the credit of charge card 104 (block 246). If any of the checks by the authorizer prove negative then the authorizer sends an unconfirmation message to “Bridge” Platform 114 (arrow 340). “Bridge” Platform 114 receives the unconfirmation message and writes a transaction summary in the database of “Bridge” Platform 114 (block 248). Additionally, “Bridge” Platform 114 sends an online unconfirmation message (block 250) both to E-Merchant 110 (arrow 350) and customer 106 (arrow 360) resulting in a no bid state (block 252). If the checks performed by the authorizer prove positive, the authorizer authorizes and executes the transaction, including paying the E-Merchant for the transaction (block 254). The E-Merchant 110 is generally paid by crediting the account of E-Merchant 110 and settling the account on a monthly basis by bank transfer. Then the authorizer sends a transaction confirmation to “Bridge” Platform 114 (block 256 and arrow 340). The transaction confirmation includes a transaction authorization reference of the authorizer. This reference is essential for the E-Merchant 110, as E-Merchant 110 does not have any other reference connecting the transaction to customer 106. “Bridge” Platform 114 receives the transaction confirmation from the authorizer and writes a transaction summary in the database of “Bridge” Platform 114 (block 258). “Bridge” Platform 114 then sends the transaction confirmation to E-Merchant 110 (arrow 350) and customer 106 (arrow 360) via distributed public network 102 (block 260). E-Merchant 110 accepts the transaction confirmation and then arranges for delivering the item purchased by customer 106 (block 262). It should be noted that “delivering” is defined herein as providing the good or service purchased either by physical delivery, by allowing download from a distributed public network, by performing a service, by renewing a subscription or membership, or by any other suitable method. The step of delivering is described in the claims as performed by E-Merchant 110. However, it should be noted that the term “delivering by the E-Merchant” is defined herein to include delivery by E-Merchant 110 or an agent or representative of E-Merchant 110. It should be noted that all the above steps are performed such that E-Merchant 110 is prevented from receiving and/or accessing any part of the charge card details of charge card 104. The term “prevented from accessing” is defined herein as meaning that even if E-Merchant 110 receives the charge card details, E-Merchant 110 cannot determine and/or use the charge card details due to encoding and/or encryption of the charge card details.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

1. A method for purchasing goods or services by a customer from an E-Merchant, the customer having a customer computer system, the customer having a charge card, the charge card having a plurality of charge card details, the method comprising the steps of:
(a) establishing a connection between the customer computer system and the E-Merchant over a distributed public network;
(b) sending at least a part of the charge card details from the customer computer system to an authorizer of the charge card, bypassing the E-Merchant, in order to purchase at least one item from the E-Merchant;
(c) sending a transaction summary from the E-Merchant to said authorizer, bypassing the customer computer system, said transaction summary being of a transaction being between the E-Merchant and the customer, said transaction including said at least one item;
(d) authorizing said transaction, by said authorizer; and
(e) sending a confirmation of said authorizing of said transaction to the E-Merchant.

2. The method of claim 1, wherein all said steps are performed such that the E-Merchant is prevented from accessing said part of the charge card details.

3. The method of claim 1, wherein said sending said part of the charge card details includes sending said part of the charge card details from the customer computer system of the customer to a “Bridge” Platform, bypassing the E-Merchant, and wherein said sending said transaction summary includes sending said transaction summary from the E-Merchant to said “Bridge” Platform, bypassing the customer computer system, the method further comprising the steps of:
(f) pairing said part of the charge card details with said transaction summary to form a combined transaction payment request package, by said “Bridge” Platform; and
(g) sending said combined transaction payment request package to said authorizer for said authorizing, by said “Bridge” Platform.

4. The method of claim 3, wherein said step of pairing is performed using a unique identification for said transaction.

5. The method of claim 4, wherein said sending said part of the charge card details includes sending said part of the charge card details and said unique identification from the customer computer system to said “Bridge” Platform, bypassing the E-Merchant and wherein said sending said transaction summary includes sending said transaction summary and said unique identification from the E-Merchant to said “Bridge” Platform, bypassing the customer computer system.

6. The method of claim 4, wherein said unique identification is an identification of said connection between the customer and the E-Merchant over said distributed public network.

7. The method of claim 3, further comprising the steps of:
(h) receiving said part of the charge card details by said “Bridge” Platform; and
(i) receiving said transaction summary by said “Bridge” Platform, wherein said receiving said part of the charge card details and said receiving said transaction summary are performed asynchronously.

8. The method of claim 3, further comprising the steps of:
(h) receiving said confirmation from said authorizer, by said “Bridge” Platform; and
(i) sending said confirmation to the E-Merchant, by said “Bridge” Platform.

9. The method of claim 8, further comprising the step of:
(j) sending said confirmation to the customer, by said “Bridge” Platform.

10. The method of claim 1, wherein said confirmation includes a transaction authorization reference of said authorizer.

11. The method of claim 1, wherein said sending said part of the charge card details is performed at least partially via said distributed public network.

12. The method of claim 1, further comprising the step of:
(f) prior to performing said sending of said part of the charge card details, performing at least one action selected from the group consisting of encoding said part of the charge card details and encrypting said part of the charge card details.

13. The method of claim 1, wherein said transaction summary includes at least one merchant detail of the E-Merchant.

14. The method of claim 13, further comprising the step of:
(f) performing a validation of the E-Merchant, by the authorizer.

15. The method of claim 1, further comprising the step of:
(f) performing a validation of said part of the charge card details, by the authorizer.

16. The method of claim 1, further comprising the step of:
(f) paying the E-Merchant for said transaction.

17. The method of claim 1, further comprising the step of:
(f) delivering said at least one item, by the E-Merchant.

18. The method of claim 1, further comprising the step of:
(f) reading said part of the charge card details from the charge card, by a card reader.

19. The method of claim 18, further comprising the step of:
(g) swiping the charge card through said card reader, by the customer, thereby enabling said card reader to read said part of the charge card details.

20. The method of claim 18, further comprising the step of:
(g) verifying a usage of the charge card by comparing a unique code associated with said card reader and at least a portion of the charge card details, wherein said step of sending said at least one charge card detail is contingent on said step of verifying.

21. The method of claim 20, further comprising the step of:
(h) storing said unique code in a non-volatile storage medium of said card reader.

22. A system for secure purchasing by customers over a distributed public network, comprising:
(a) a plurality of customer computer systems, each of said customer computer systems being uniquely associated with one of the customers;
(b) a plurality of servers associated hosting a plurality of E-Merchants, said customer computer systems and said E-Merchants being configured to establish connections over the distributed public network in order for at least one of the customers to purchase at least one item from one of said E-Merchants;
(c) a computer system hosting a “Bridge” platform configured to pair:
(i) a transaction summary sent by said one E-Merchant to said “Bridge” platform, bypassing the one customer; and
(ii) at least part of a charge card details of a credit card of the one customer, sent by the one customer to said “Bridge” platform, bypassing said one E-Merchant, in order to form a combined transaction payment request package; and
(d) at least one card issuer configured to authorize said combined transaction payment request package sent by said “Bridge” platform.

23. The system of claim 22, wherein each of said customer computer systems includes a card reader configured for reading card details of the customers for sending to said “Bridge” platform.
